(19) United States
(12) Patent Application Publication
(10) Pub. No.: US 2003/0055672 A1
(43) Pub. Date: Mar. 20, 2003

(54) Method of defining functional configuration of business application system

(75) Inventors: Mari Inoki, Tokyo (JP); Koichi Nomura, Tokyo (JP); Ayumu Tahara, Tokyo (JP); Mari Kaibe, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 10/235,708

(22) Filed: Sep. 6, 2002

(30) Foreign Application Priority Data
Sep. 17, 2001 (JP) 2001-282168

(51) Int. Cl. G06F 17/50; G06F 17/60

(52) U.S. Cl. 705/1; 703/1

(57) ABSTRACT

The method defines a functional configuration of a business application system. The method is capable of reducing the time required to carry out a requirements definition step and of defining a unified functional configuration to efficiently share and reuse common components. A functional configuration definition support system 10 has an input control part 11, an output control part 12, a functional configuration defining part 13, a function model database 14, and a functional configuration generation result database 15. The functional configuration defining part 13 generates a functional configuration of a business application system to be designed, on the basis of a function model representing a typical functional configuration of a general business application system, which is stored in the function model database 14, in accordance with input information delivered via the input control part 11.

### BACKGROUND OF THE INVENTION

1. Field of The Invention

The present invention generally relates to a technique for carrying out a requirements definition (function definition) of a business application system. More specifically, the invention relates to a method of defining a functional configuration of a business application system to be designed, in which the functional configuration is defined on the basis of a function model representing a typical functional configuration of a general business application system. The invention further relates to a system and a program product as a support tool for realizing the method, and a function model class library product (framework).

2. Description of The Related Art

In general, when a business application system is constructed, there is required a step (requirements definition step) of collecting requirements from software users about the business application system to be designed, and describing a functional configuration according to the requirements.

However, in the conventional requirements definition step, functions are independently extracted from respective business application systems; thus, even in a case where it is possible to define the functions of a business application system as a combination of basic function elements, it is often defined that each business application system has individual functions, so that there is a problem in that it takes an excessive time to carry out the requirements definition step.

In addition, since functional configurations defined at the conventional requirements definition step are not unified, it is difficult to find similar and/or common portions at a design step and/or a producing step, even in the case of similar business application systems, so that there is a problem in that it is not possible to efficiently share and reuse common components.

### SUMMARY OF THE INVENTION

It is therefore an object of the present invention to eliminate the aforementioned problems and to provide a method of defining a functional configuration of a business application system, a system and a program product for realizing the method, and a function model class library product, which are capable of reducing the time required to carry out a requirements definition step and capable of defining a unified functional configuration to efficiently share and reuse common components.

In order to accomplish the aforementioned and other objects, according to one aspect of the present invention, there is provided a method of defining a functional configuration of a business application system to be designed. The method comprises the steps of: defining a workflow indicating a flow of services; extracting, from the defined workflow, information utilized or prepared in each stage of the flow of services; and generating a functional configuration of the business application system to be designed, by choosing a desired function element with reference to a function model representing a typical functional configuration of a general business application system, for every extracted information, and customizing the chosen function element in accordance with the extracted information.

The method may further comprise the step of selecting a desired result of generation of functional configuration from a plurality of results of generation of functional configuration generated in the past, wherein at the step of generating the functional configuration, the desired function element is chosen with reference to the selected result of generation of functional configuration, and the function model.

The function model may include: a registration/update function group for inputting, registering, deleting and updating information; a retrieval/reference function group for retrieving, referring to, displaying and listing information; a batch processing function group for carrying out a statistic calculation, a fee calculation, a data backup and a data deletion; a system management function group for carrying out a master management and an operation management; and a utility function group for carrying out printing, mail transmission, data generation, data WWW disclosure, certification, mail notification, data acquisition and data presentation.

According to another aspect of the present invention, there is provided a system of supporting the definition of a functional configuration of a business application system to be designed. The system comprises: a function model database that stores a function model representing a typical functional configuration of a general business application system; and a functional configuration defining part that generates a functional configuration of the business application system to be designed, on the basis of the function model stored in the function model database, in accordance with input information inputted by a user, wherein the functional configuration defining part includes: a workflow definition support part that supports the definition of a workflow indicating a flow of services; a utilization/preparation information extraction support part that supports an extraction of information utilized or prepared in each stage of the flow of services, on the basis of the workflow defined by the workflow definition support part; and a functional configuration generating part that generates a functional configuration of the business application system to be designed, by allowing a user to choose a desired function element with reference to the function model stored in the function model database, for every information extracted by the utilization/preparation information extraction support part, and customizing the chosen function element in accordance with the extracted information.

The system may further comprise a functional configuration generation result database that stores a plurality of results of generation of functional configuration obtained by the functional configuration defining part, wherein the functional configuration defining part further includes: a functional configuration registering part that registers a functional configuration generated by the functional configuration generating part, in the functional configuration generation result database as a result of generation of functional configuration; and a functional configuration referring part that selects a desired result of generation of functional configuration from a plurality of results of generation of functional configuration registered in the functional configuration generation result database, the functional configuration generating part allowing a user to choose a desired function element with reference to the result of generation of functional configuration selected by the functional configuration referring part, and the function model stored in the function model database.

According to a further aspect of the present invention, there is provided a program product of supporting the definition of a functional configuration of a business application system to be designed. The program product causes a computer to execute the procedures of: supporting the definition of a workflow indicating a flow of services; supporting the extraction of information utilized or prepared in each stage of the flow of services, on the basis of the defined work flow; and generating a functional configuration of the business application system to be designed, by allowing a user to choose a desired function element with reference to a function model representing a typical functional configuration of a general business application system, for every extracted information, and customizing the chosen function element in accordance with the extracted information.

The program product may further cause the computer to execute the procedure of selecting a desired result of generation of functional configuration from a plurality of results of generation of functional configuration generated in the past, wherein at said procedure of generating the functional configuration, the user is allowed to choose the desired function element with reference to the selected result of generation of functional configuration, and the function model.

According to a still further aspect of the present invention, there is provided a function model class library product used for defining a functional configuration of a business application system to be designed. The function model class library product comprises: a function model class for controlling a function group of a business application system; a service function group combination class inherited from the function model class and controlling a combination of function groups of the business application system to be designed; a registration/update class inherited from the function model class and controlling a registration/update function group; a retrieval/reference class inherited from the function model class and controlling a retrieval/reference function group; a batch processing class inherited from the function model class and controlling a batch processing function group; a system management class inherited from the function model class and controlling a system management function group; and a utility class inherited from the function model class and controlling a utility function group. The registration/update class may have the function of inputting, registering, deleting and updating information and the function indicative of a combination thereof, as subclasses The retrieval/reference class may have the function of retrieving, referring to, displaying and listing information and the function indicative of a combination thereof, as subclasses. The batch processing class may have the function of carrying out a statistic calculation, a fee calculation, a data backup and a data deletion and the function indicative of a combination thereof, as subclasses. The system management class may have the function of carrying out a master management and an operation management and the function indicative of a combination thereof, as subclasses. The utility class may have the function of carrying out printing, mail transmission, data generation, data WWW disclosure, certification, mail notification, data acquisition and data presentation and the function indicative of a combination thereof, as subclasses.

According to the present invention, the typical functional configuration of a general business application system is prepared as a reusable function model to choose the function elements of the function model every information utilized or prepared in each stage of the flow of services; and the chosen function elements are customized in accordance with the extracted information to generate a functional configuration of the business application system to be designed. Therefore, it is possible to reduce the time required to carry out the requirements definition step. In addition, it is possible to define unified functional configurations, so that it is possible to efficiently share and reuse common components.

### BRIEF DESCRIPTION OF THE DRAWINGS

The present invention will be understood more fully from the detailed description given herebelow and from the accompanying drawings of the preferred embodiments of the invention. However, the drawings are not intended to imply limitation of the invention to a specific embodiment, but are for explanation and understanding only.

In the drawings:

FIG. 1 is a block diagram showing the whole configuration of a preferred embodiment of a functional configuration definition support system according to the present invention;

FIG. 2 is a block diagram showing the details of a functional configuration defining part of the functional configuration definition support system shown in FIG. 1;

FIG. 3 is a diagram showing a function model for use in the functional configuration definition support system shown in FIG. 1;

FIG. 4 is a diagram showing an example of a storage form when the function model shown in FIG. 3 is stored in the form of a class library;

FIG. 5 is a diagram showing an example of a description form of a function model based on XML;

FIG. 6 is a diagram showing a storage form when the function model shown in FIG. 3 is stored as an XML file in accordance with the description form shown in FIG. 5;

FIG. 7 is a diagram showing a storage form when the function model shown in FIG. 3 is stored as an XML file in accordance with the description form shown in FIG. 5;

FIG. 8 is a flow chart for explaining the procedure for carrying out a preferred embodiment of a functional configuration defining method according to the present invention;

FIG. 9 is a diagram showing an example of a flow of services and extracted information in an article procuring service;

FIG. 10 is a diagram showing a result of selection of function elements from the function model of FIG. 3, with respect to information on public-notification of invitation for materials, which is prepared in the material inviting service of the article procuring service shown in FIG. 9;

FIG. 11 is a diagram showing an example of a result of generation of functional configuration with respect to the information on public-notification of invitation for materials, which is prepared on the basis of the result of selection shown in FIG. 10;

FIG. 12 is a diagram showing an example of a storage form when the result of generation of functional configuration shown in FIG. 11 is stored as a class library;

FIG. 13 is a diagram showing an example of a storage form when the result of generation of functional configuration shown in FIG. 11 is stored as an XML file;

FIG. 14 is a diagram showing an example of implementation for realizing a function model, which is used in the functional configuration definition support system shown in FIG. 1, as a class library;

FIG. 15 is a diagram showing a result of selection and derivation of a class corresponding to a desired function element from the function model (class library) shown in FIG. 14, with respect to the information on public-notification of invitation for materials, which is prepared in the material inviting service of the article procuring service shown in FIG. 9;

FIG. 16 is a diagram showing a combination of subclasses derived as shown in FIG. 15, and a result of assignment of the relationship between controls;

FIG. 17 is a diagram showing a result of selection and derivation of a class corresponding to a desired function element from the function model (class library) shown in FIG. 14, with respect to information on public-notification of invitation for opinions, which is prepared in an opinion inviting service of the article procuring service shown in FIG. 9;

FIG. 18 is a diagram showing a combination of subclasses derived as shown in FIG. 17, and a result of assignment of the relationship between controls;

FIG. 19 is a diagram showing an example of a functional configuration, which is generated as shown in FIGS. 15 and 16, to the user with respect to the material inviting service of the article procuring service shown in FIG. 19;

FIG. 20 is a diagram showing an example of a functional configuration, which is generated as shown in FIGS. 17 and 18, to the user with respect to the opinion inviting service of the article procuring service shown in FIG. 9;

FIG. 21 is a diagram showing a result of selection and derivation of a class corresponding to a desired function element from the function model (class library) shown in FIG. 14, with respect to the material inviting service and opinion inviting service of the article procuring service shown in FIG. 9;

FIG. 22 is a diagram showing a data format for storing a result of generation of functional configuration in a database;

FIG. 23 is a diagram showing an example of a result of generation of functional configuration with respect to the material inviting service and the opinion inviting service, the example being expressed in accordance with the format shown in FIG. 22; and

FIG. 24 is a diagram showing an example of a computer system in which the functional configuration definition support system shown in FIGS. 1 and 2 is applied.

### DESCRIPTION OF THE PREFERRED EMBODIMENTS

Referring now to the accompanying drawings, the preferred embodiment of the present invention will be described below.

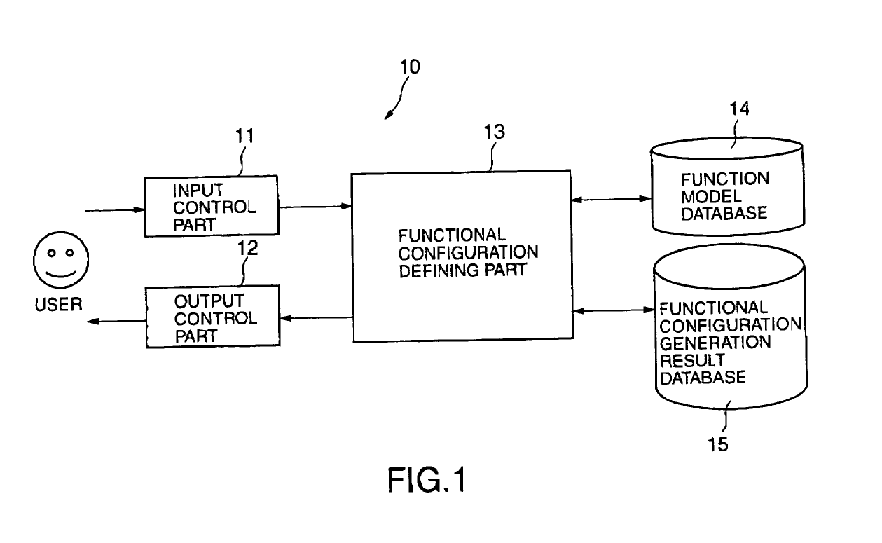

FIG. 1 is a block diagram showing the whole configuration of a preferred embodiment of a functional configuration definition support system according to the present invention.

As shown in FIG. 1, a functional configuration definition support system 10 in this preferred embodiment is intended to support the definition of a functional configuration of a business application system to be designed, and comprises an input control part 11, an output control part 12, a functional configuration defining part 13, a function model database 14 and a functional configuration generation result database 15.

The input control part 11 is designed to acquire input information inputted by the user, and to deliver it to the functional configuration defining part 13 for managing the control of the whole system

The output control part 12 is designed to present information, which is obtained from the functional configuration defining part 13, to the user as output information.

The functional configuration defining part 13 is designed to generate a functional configuration of a business application system to be designed, in accordance with the input information delivered via the input control part 11.

The function model database 14 is a database for storing a function model representing a typical functional configuration of a general business application system.

The functional configuration generation result database 15 is a database for storing a result of generation of functional configuration obtained by the functional configuration defining part 13.

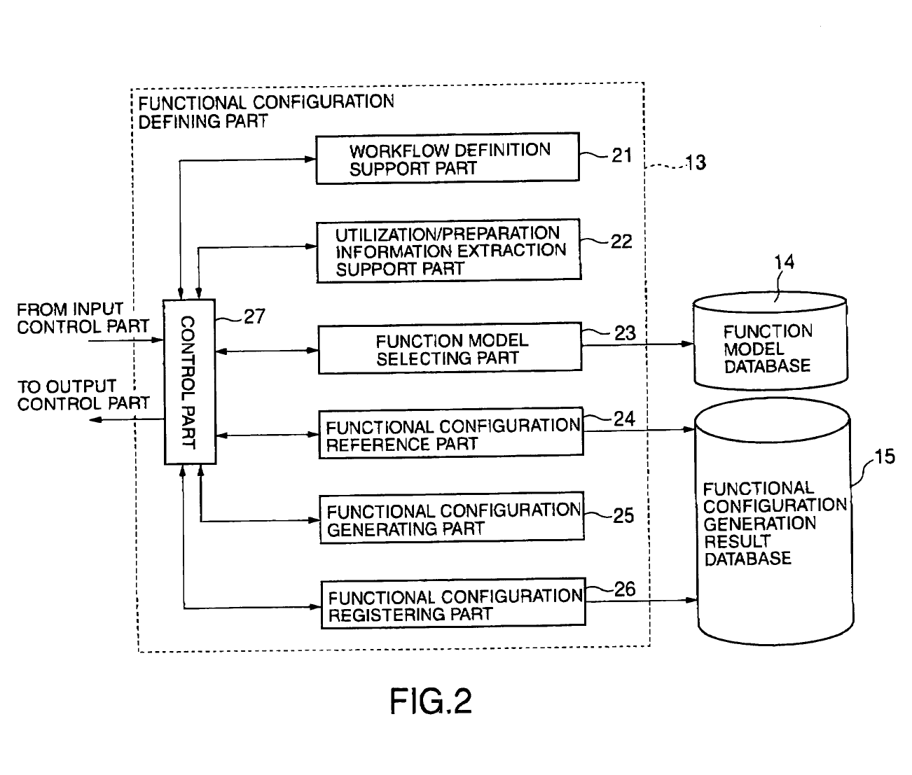

FIG. 2 is a block diagram showing the details of the functional configuration defining part 13 of the functional configuration definition support system 10 shown in FIG. 1.

As shown in FIG. 2, the functional configuration defining part 13 comprises a workflow definition support part 21, a utilization/preparation information extraction support part 22, a function model selecting part 23, a functional configuration reference part 24, a functional configuration generating part 25, a functional configuration registering part 26, and a control part 27.

The workflow definition support part 21 is a means for supporting the definition of a workflow indicating the flow of services.

The utilization/preparation information extraction support part 22 is a means for inputting the workflow, which is defined by the workflow definition support part 21, to support the extraction of information utilized or prepared in each stage of the flow of services.

The function model selecting part 23 is a means for selecting a desired function model from function models stored in the function model database 14,

The functional configuration reference part 24 is a means for selecting and making a reference to a desired result of generation of functional configuration from past prepared results of generation of functional configuration stored in the functional configuration generation result database 15.

The functional configuration generating part 25 is a means for choosing a desired function element while making a reference to the function model selected by the function model selecting part 23, and the result of generation of functional configuration selected by the functional configuration reference part 24, every information extracted by the utilization/preparation information extraction support part 22, to customize (define a how-to-use specialized in information) the chosen function element in accordance with the extracted information to generate the functional configuration of a business application system to be designed.

The functional configuration registering part 26 is a means for registering the functional configuration, which is generated by the functional configuration generating part 25, in the functional configuration generation result database 15 as a result of generation of functional configuration.

The control part 27 is designed to control the workflow definition support part 21, the utilization/preparation information extraction support part 22, the function model selecting part 23, the functional configuration reference part 24, the functional configuration generating part 25 and the functional configuration registering part 26 to acquire information from these parts and input information inputted by the input control part 11, to deliver information to a corresponding part in accordance with status. If necessary, the control part 27 is also designed to deliver information, which is obtained by each part, to the output control part 12.

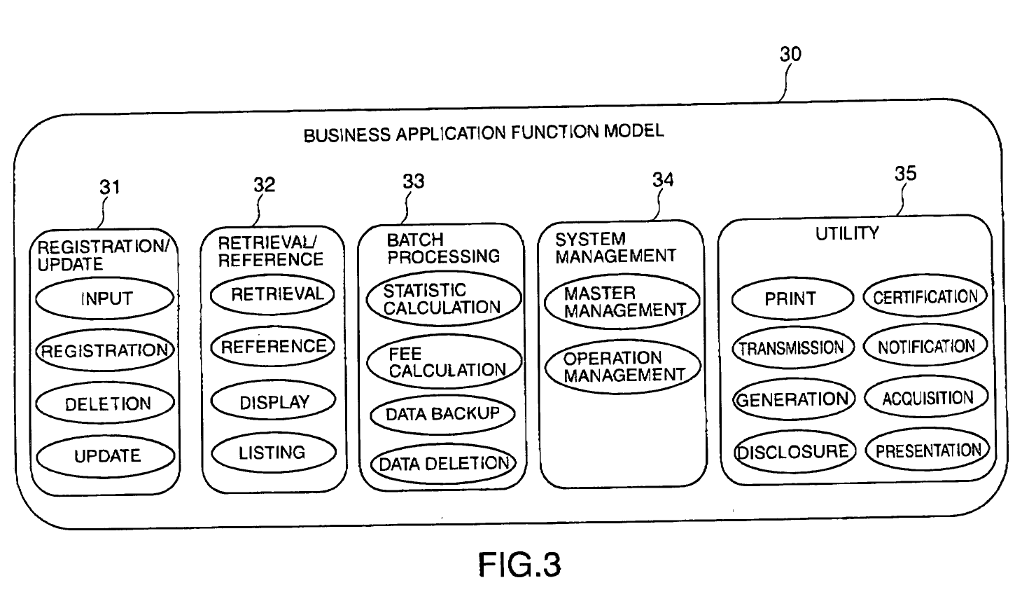

FIG. 3 is a diagram showing a function model for use in the functional configuration definition support system 10 shown in FIG. 1.

As shown in FIG. 3, the function model 30 is indicated by a typical functional configuration of a business application system (domain), and comprises a registration/update function group 31, a retrieval/reference function group 32, a batch processing function group 33, a system management function group 34 and a utility function group 35.

The registration/update function group 31 is a function group for inputting, registering, deleting and updating information.

The retrieval/reference function group 32 is a function group for retrieving, referring to, displaying and listing information.

The batch processing function group 33 is a function group for carrying out a statistical calculation, a fee calculation, a data backup, and a data deletion.

The system management function group 34 is a function group for carrying out a master management and an operation management.

The utility function group 35 is a function group for carrying out printing, mail transmission, data generation, data WWW disclosure, certification, mail notification, data acquisition and data presentation.

Furthermore, the function model 30 shown in FIG. 3 is stored in a predetermined form in the function model database 14 of the functional configuration definition support system 10.

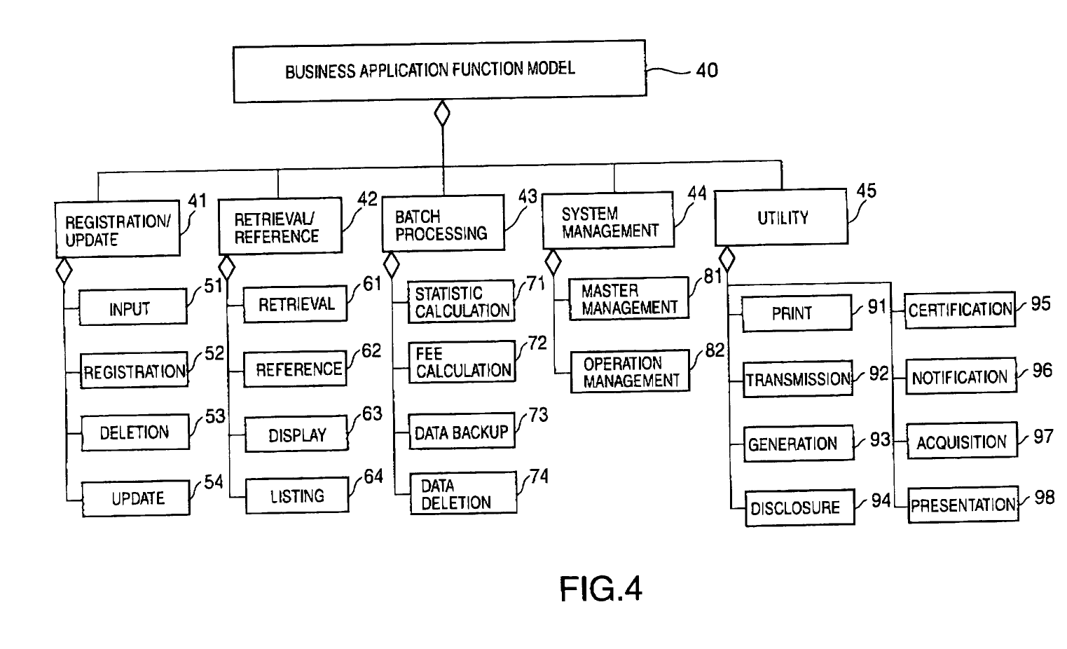

FIG. 4 is a diagram showing an example of a storage form when the function model 30 shown in FIG. 3 is stored in the form of a class library. FIG. 4 shows a class library by the UML (Unified Modeling Language) being an expression language for a figure in an object-oriented technique. In this figure, the notation of a rectangle denotes a class, and the notation of a straight line denotes the relationship between classes. The notation of a rhombus shows that a class contacting a rhombus possesses the other class connected thereto.

In the storage form shown in FIG. 4, the function model class 40 has a registration/update class 41, a retrieval/reference class 42, a batch processing class 43, a system management class 44 and a utility class 45 as subclasses.

The registration/update class 41 has the function of inputting, registering, deleting and updating information, as classes 51 through 54.

The retrieval/reference class 42 has the function of retrieving, referring to, displaying and listing information, as classes 61 through 64.

The batch processing class 43 has the function of carrying out a statistic calculation, a fee calculation, a data backup and a data deletion, as classes 71 through 74.

The system management class 44 has the function of carrying out a master management and an operation management as classes 81 and 82.

The utility class 45 has the function of carrying out printing, mail transmission, data generation, data WWW disclosure, certification, mail notification, data acquisition and data presentation.

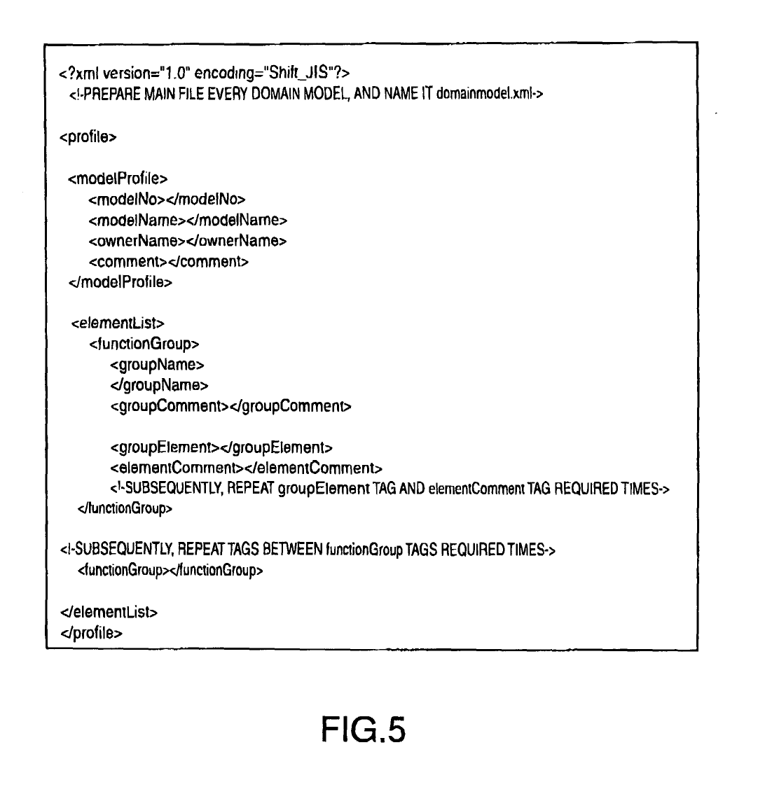

FIGS. 5 through 7 are diagrams for explaining a storage form when the function model 30 shown in FIG. 3 is stored as an XML (eXtensible Markup Language) file.

FIG. 5 is a diagram showing an example of a description form of a function model by the XML.

As shown in FIG. 5, the XML file is generally divided into a portion sandwiched between <modelProfile> and </modelProfile>, and a portion sandwiched between <elementList> and </modelProfile>. In the portion sandwiched between <modelprofile> and </modelProfile>, a management number and name of a function model, manager's name and comments are described, In the portion sandwiched between <elementList> and </elementList>, a function model is described. Among the portion sandwiched between <elementList> and </elementList>, in a portion sandwiched between <functionGroup> and </functionGroup>, function elements including the name of a function group and the function group are described, and in a portion sandwiched between <groupElement> and </groupElement>, a function name is described.

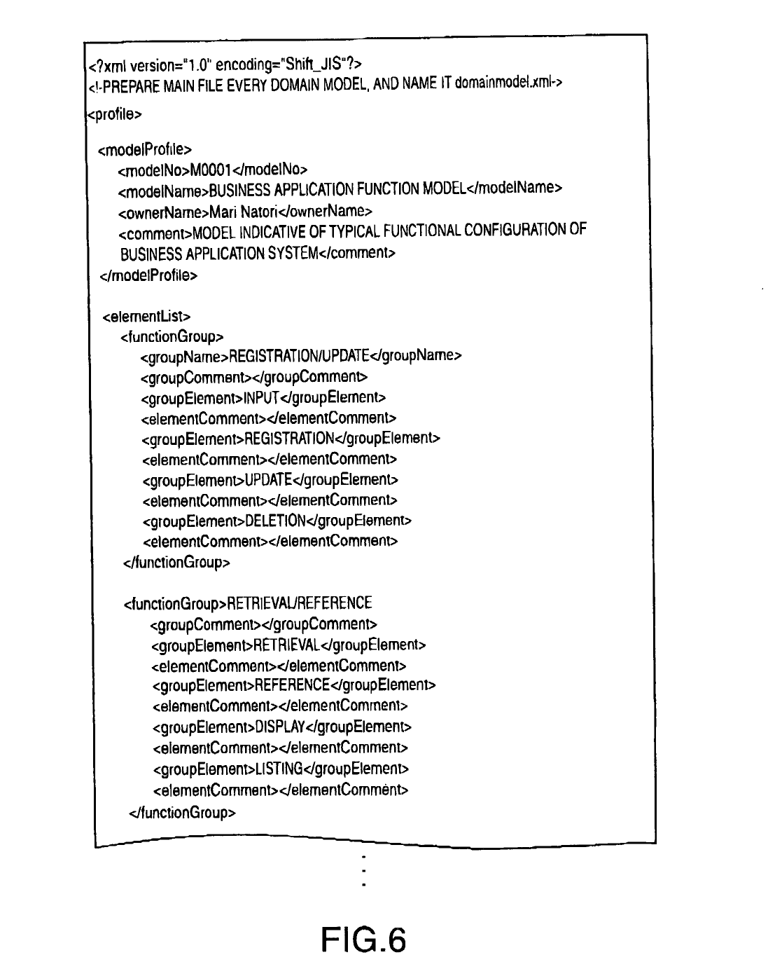

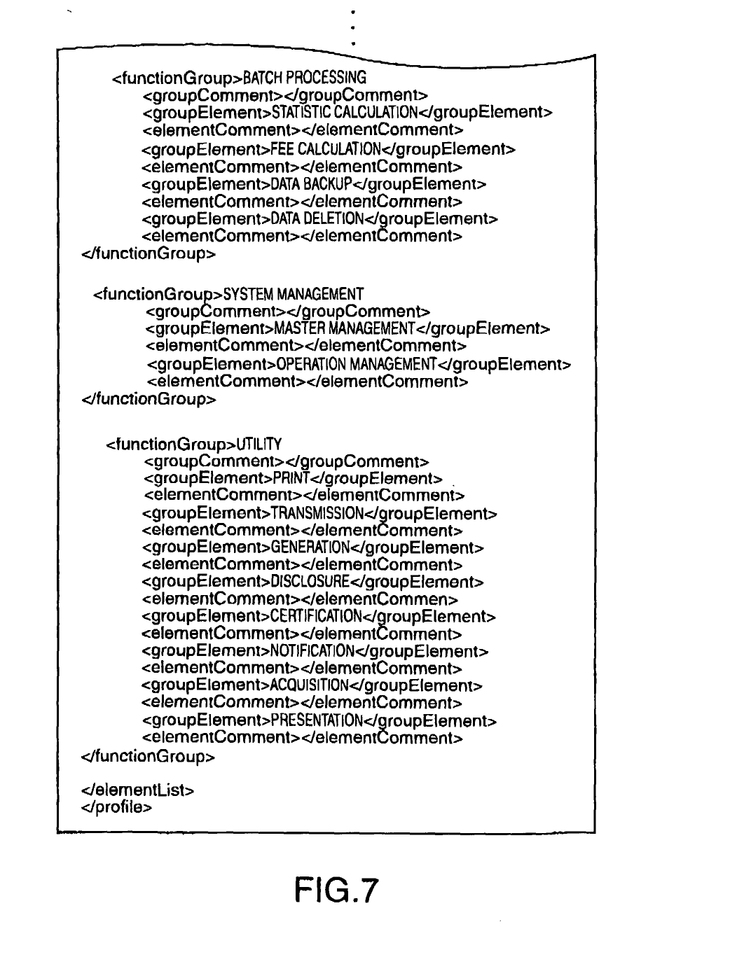

FIGS. 6 and 7 are diagrams showing a storage form when the function model 30 shown in FIG. 3 is stored as an XML file in accordance with the description form shown in FIG. 5.

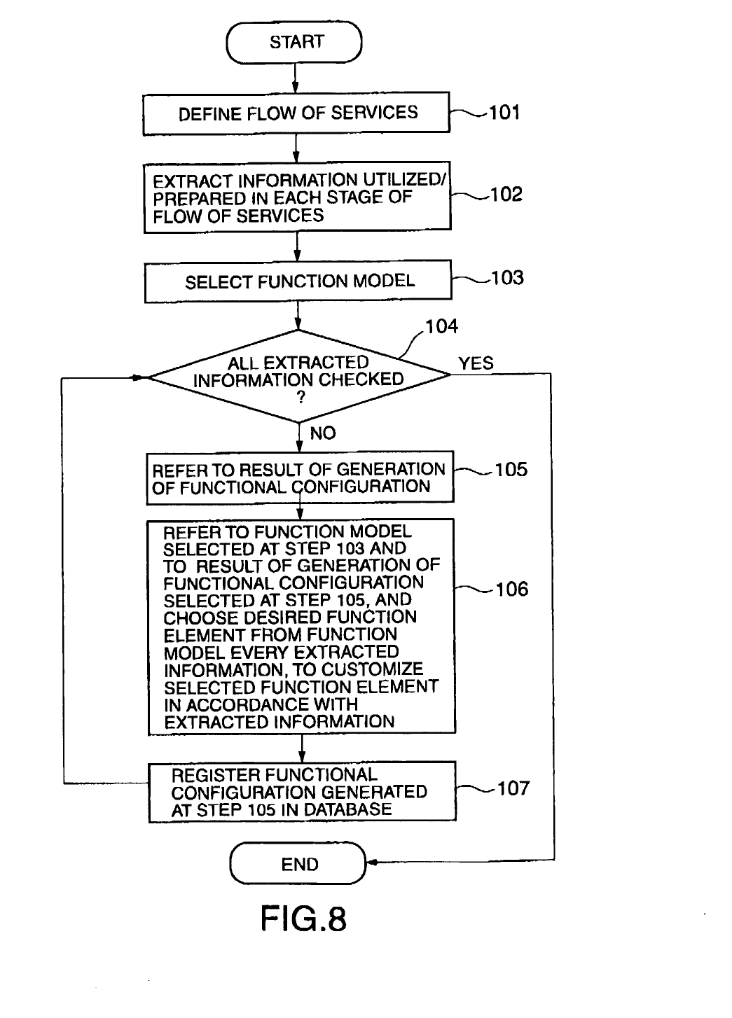

Referring to FIG. 8, the procedure for carrying out a method of defining a functional configuration using the functional configuration definition support system 10 shown in FIGS. 1 and 2 will be described below.

First, by the control part 27 of the functional configuration defining part 13, the workflow definition support part 21 is started to accept input information, which is inputted by the user via the input control part 11, while presenting a graphical user interface to the user via the output control part 12, to support the user to define a workflow indicating the flow of services (step 101).

Then, the utilization/preparation information extraction support part 22 is started to accept input information, which is inputted by the user via the input control part 11, while presenting a graphical user interface to the user via the output control part 12, to support the user to extract information utilized or prepared in each stage of the workflow defined at step 101 (step 102).

Thereafter, the function model selecting part 23 is started to select a desired function model from the function models, which are stored in the function model database 14, in accordance with the input information inputted by the user via the input control part 11 (step 103).

Then, the processes of the following steps 105 through 107 are repeated every information extracted at step 102 (step 104).

Specifically, first, the functional configuration reference part 24 is started to select a desired result of generation of functional configuration from past prepared results of generation of functional configuration stored in the functional configuration result database 15 (step 105).

Then, the functional configuration generating part 25 is started to accept input information, which is inputted by the user via the input control part 11, while presenting a graphical user interface to the user via the output control part 12, to generate the functional configuration of a business application system to designed (step 106). Specifically, the user makes a reference to the function model, which is selected at step 103, and the result of generation of functional configuration, which is selected at step 105, to choose a desired function element to customize the chosen function element in accordance with the extracted information to generate the functional configuration of a business application system to be designed.

Thereafter, the functional configuration registering part 26 is started to register the functional configuration, which is generated at step 106, in the functional configuration generation result database 15 as a result of generation of functional configuration (step 107).

Furthermore, if the result of generation of functional configuration is registered with respect to all information extracted at step 102, the whole processing is completed.

Thus, according to this preferred embodiment, the typical functional configuration of a general business application system is prepared as a reusable function model to choose the function elements of the function model every information utilized or prepared in each stage of the flow of services; and the chosen function elements are customized in accordance with the extracted information to generate a functional configuration of the business application system to be designed. Therefore, it is possible to reduce the time required to carry out the requirements definition step. In addition, it is possible to define unified functional configurations, so that it is possible to efficiently share and reuse common components. That is, if a common component (a framework or function component) is prepared every function element of the function model, it is possible to develop a business application system by assembling the existing common components in a design step or producing step.

In addition, according to this preferred embodiment, it is possible to choose a desired function element while making a reference to a past prepared generated result of functional configuration with the chosen function model, so that it is possible to more efficiently define the functional configuration of the business application system.

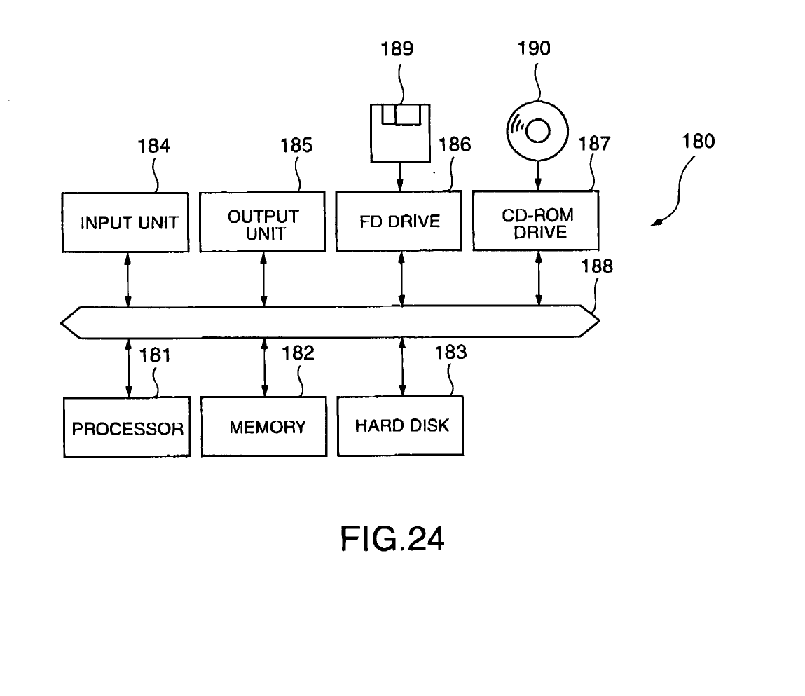

Furthermore, in the above described preferred embodiment, the functional configuration definition support system 10 can be realized as a program product executed on a computer system 180 shown in FIG. 24. The function model can also be realized as a class library (framework) or file which is installed on the computer system 180 shown in FIG. 24. The computer system 180 comprises a bus 188, a processor 181 connected to the bus 188, a memory 182, a hard disk 183, an input unit 184, such as a peripheral unit (a key board, a mouse or the like), connected to the bus 188, an output unit 185, such as a display or a printer, an FD drive 186 and a CD-ROM drive 187. The above described program product and class library product can be stored in a computer readable recording medium, such as the memory 182, the hard disk 183, a flexible disk 189 or a CD-ROM 190, to be sequentially read out and executed by the processor 181 to realize the above described function or procedure.

The recording medium should not be limited to the flexible disk or CD-ROM, and its recording form may be any form if it is a recording medium, which can record programs or the like and which can be read by a computer, such as a magnetic disk, an internal memory, a hard disk, an optical disk (CD-R, DVD (Digital Versatile Disk) or the like), an optical magnetic disk (MO (Magneto Optical) or the like), or a semiconductor memory. In addition, the recording media include carrier waves transmitted on a network, and information transmitting media.

In addition, the recording media should not be limited to media independent of computers, but they include recording media in which a framework transmitted by LAN or Internet has been downloaded to be stored or temporarily stored.

Moreover, the number of recording media should not be limited to one. The recording media include a plurality of media in which the framework has been recorded, and the construction of the media may be any construction.

### EXAMPLES

Examples of the above described preferred embodiments will be described below. As an example, with respect to an article procuring service carried out in national agencies or autonomous communities, a method of defining the functional configuration of a business application system carried out in accordance with the procedure shown in FIG. 8 will be described below.

[Definition of Flow of Services]

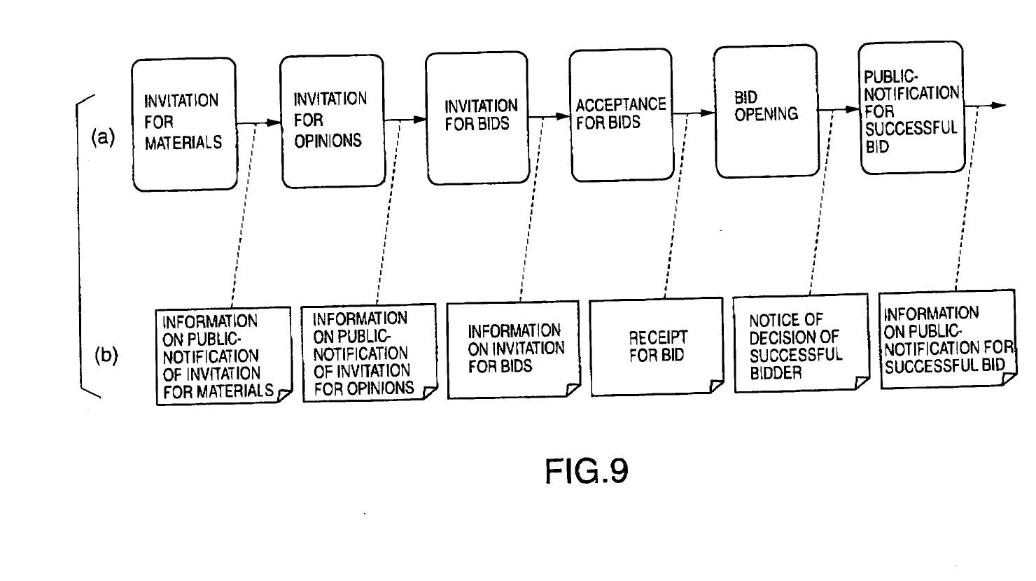

First, the user defines a workflow indicating the flow of services of an article procuring business (step 101). FIG. 9(a) is a diagram showing an example of the flow of services in an article procuring service. As shown in FIG. 9(a), the article procuring service is defined so as to include services in the respective stages of an invitation for materials, an invitation for opinions, an invitation forbids, an acceptance for bids, a bid opening and a public-notification for successful bit.

[Extraction of Information]

Then, the user extracts information utilized or prepared in each stage of the flow of the article procuring service (step 102). FIG. 9(b) is a diagram showing an example of information to be extracted. As shown in FIG. 9(b), information on public-notification of invitation for materials is prepared in a material inviting service, and information on public-notification of invitation for opinions is prepared in an opinion inviting service. In addition, information on invitation for bids is prepared in a bid public-notifying service, and a receipt for bid is prepared in a bid accepting service. Moreover, a notice of decision of successful bidder is prepared in a bid opening service, and information on public-notification for successful bit is prepared in a successful bid public-notifying service. Therefore, as information prepared in the respective stages, the information on public- notification of invitation for materials, the information on public-notification of invitation for opinions, the information on invitation for bids, the receipt for bid, the notice of decision of successful bidder, and the information on public-notification for successful bid are extracted.

[Selection of Function Model]

Thereafter, the function model 30 shown in FIG. 3 is selected from the function models stored in the function model database 14 (step 103).

Then, the functional configuration of the business application system to be designed is generated every information extracted at step 102 (step 106). Specifically, with reference to the function model 30 shown in FIG. 3, a desired function element is chosen, and the chosen function element is customized in accordance with the extracted information to generate the functional configuration of the business application system to be designed.

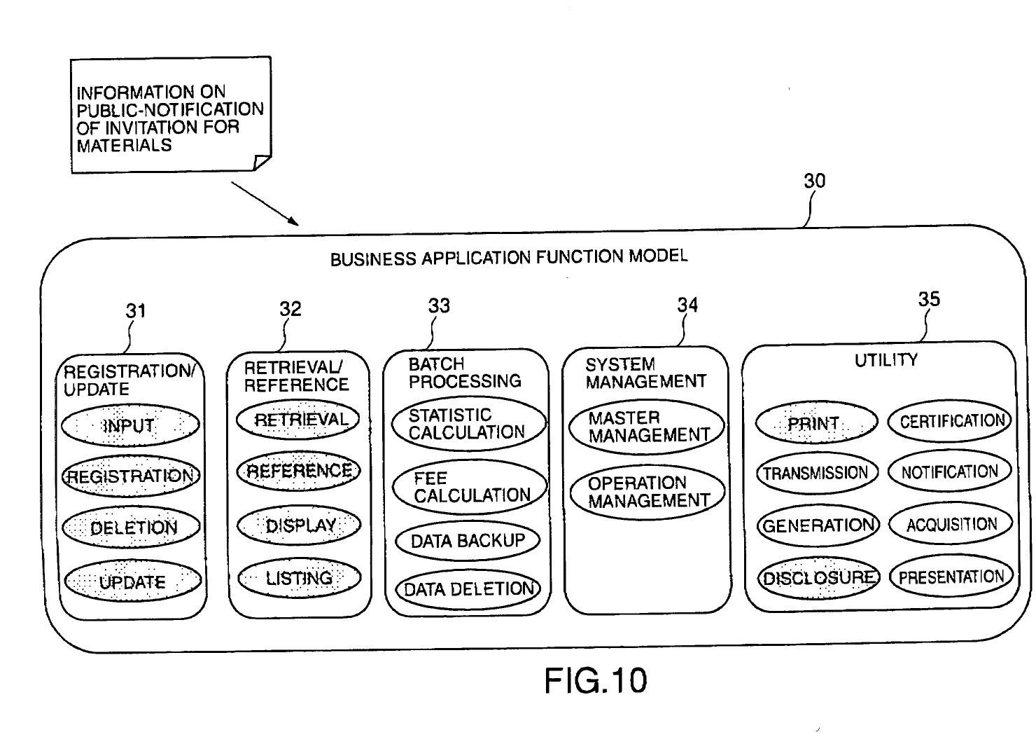

FIG. 10 is a diagram showing a result of selection of a functional configuration from the function model 30 shown in FIG. 3. As shown in FIG. 10, in this case, the function of inputting, registering, deleting and updating information is selected from the registration/update function group 31, the function of retrieving, referring to, displaying and listing information is selected from the retrieval/reference function group 32, and the function of carrying out printing and data WWW disclosure is selected from the utility function group 35. Furthermore, any functions are not selected from the batch processing function group 33 and the system management function group 34.

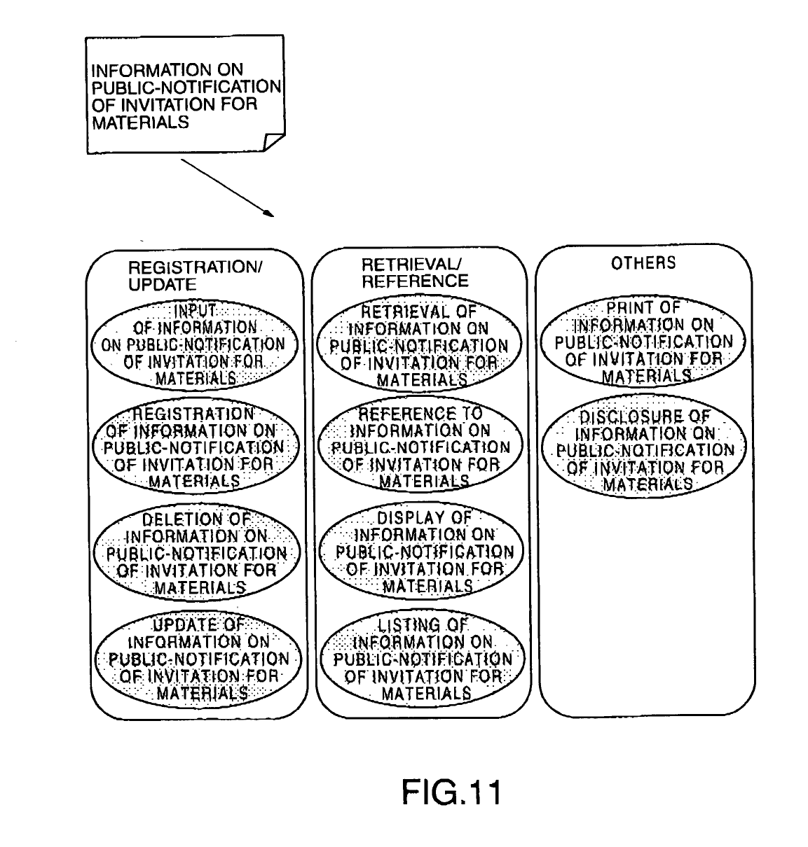

A result of generation of functional configuration with respect to information on public-notification of invitation for materials, which is prepared on the basis of such a result of selection, is shown in FIG. 11.

[Registration of Result of Generation of Functional Configuration]

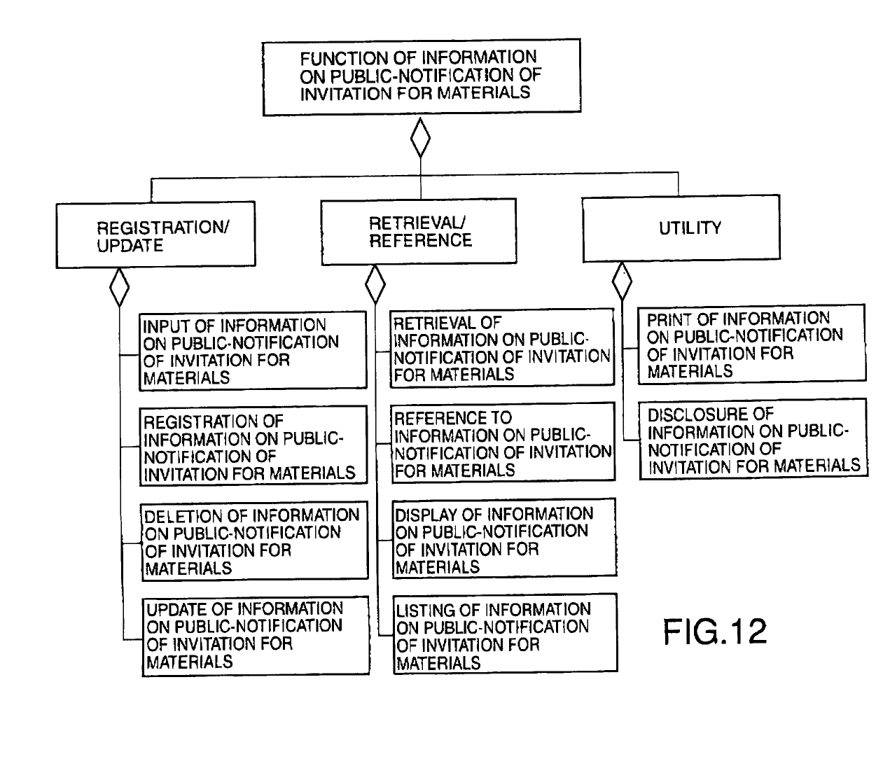

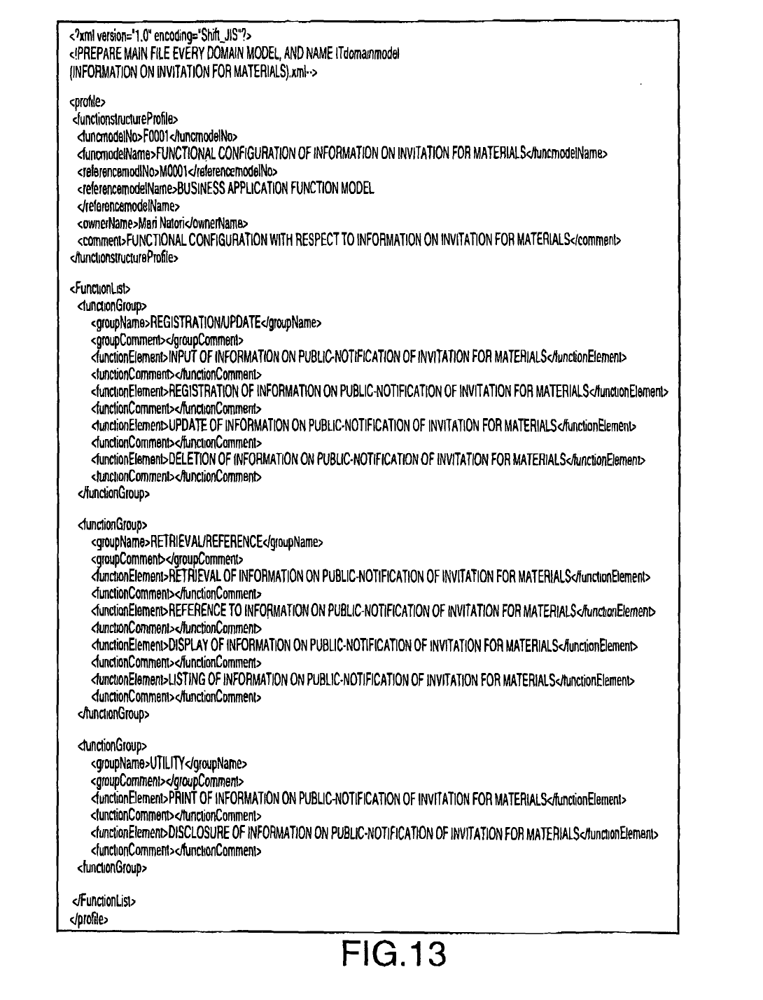

Thereafter, the result of generation of functional configuration shown in FIG. 11 is stored in the functional configuration generation result database 15 in the form of the class library (see FIG. 12) or in the form of the XML file (see FIG. 13) (step 107).

Furthermore, the XML file shown in FIG. 13 is generally divided into a portion sandwiched between <functionstructureProfile> and </functionstructureProfile>, and a portion sandwiched between <functionList> and </functionList>. In the portion sandwiched between <functionstructureProfile> and </functionstructureProfile>, a management number and name of a functional configuration, manager's name, comments, and a management number and name of a function model to which a reference is made are described. In the portion sandwiched between <functionList> and </functionList>, a functional configuration is described. Among the portion sandwiched between <elementList> and </elementList>, in a portion sandwiched between <functionGroup> and </functionGroup>, function elements including the name of a function group and the function group are described, and in a portion sandwiched between <functionElement> and </functionElement>, a function name is described.

[Repeated Processing]

Then, the processes of the above described steps 105 through 107 are repeated every information (the information on public-notification of invitation for opinions, the information on invitation for bids, the receipt for bid, the notice of decision of successful bidder, and the information on public-notification for successful bid) extracted at step 102 (step 104)

[Reference to Past Stored Result of Generation of Functional Configuration]

If necessary, a desired result of generation of functional configuration may be selected from the past prepared results of generation of functional configuration which are stored in the functional configuration result database 15 (step 105), and a reference to the selected result may be made when a functional configuration is generated at step 106.

[Example of Implementation]

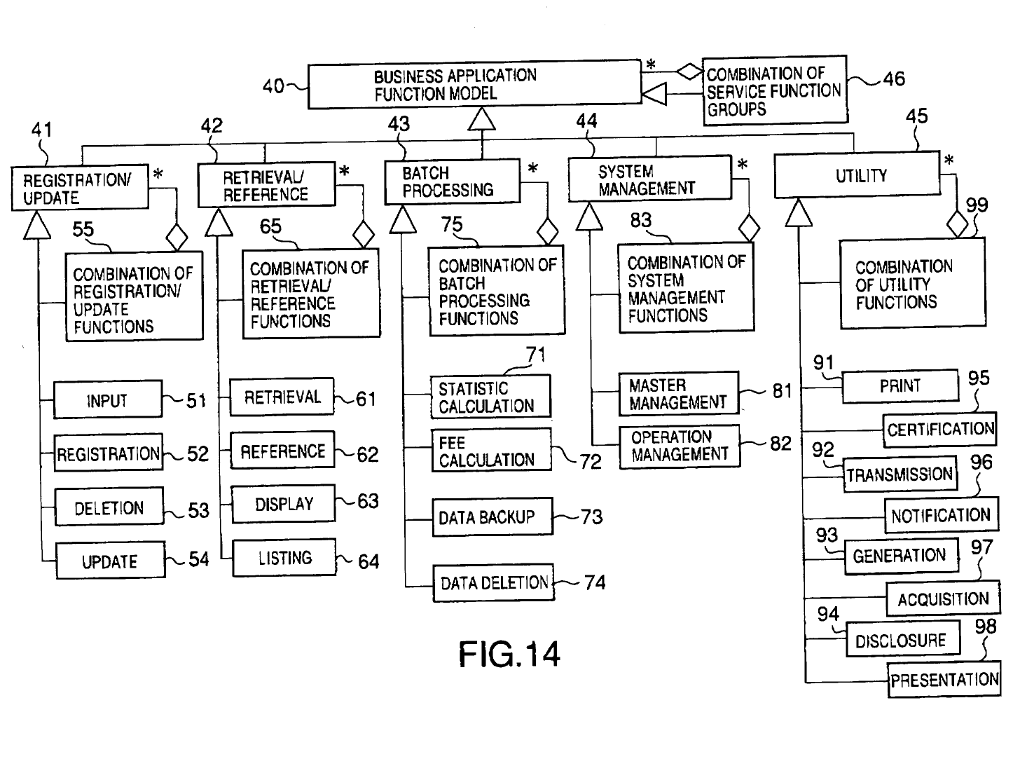

In the above described preferred embodiment, the function model stored in the function model database 14 can be prepared as a class library shown in FIG. 14. In this case, by deriving subclasses from a class included in the class library being a function model, the functional configuration of the business application system to be designed can be directly generated as a class group.

In the class library shown in FIG. 14, the function model class 40 being a class for controlling the function groups of the business application system has a registration/update class 41, a retrieval/reference class 42, a batch processing class 43, a system management class 44, a utility class 45 and a service function group combination class 46, as subclasses inheriting from it.

The registration/update class 41 is a class for controlling a group of registration/update functions, and has the function of inputting, registering, deleting and updating information and the function indicative of a combination thereof, as subclasses 51 through 55.

The retrieval/reference class 42 is a class for controlling a group of retrieval/reference functions, and has the function of retrieving, referring to, displaying and listing information and the function indicative of a combination thereof, as subclasses 61 through 65.

The batch processing class 43 is a class for controlling a group of batch processing functions, and has the function of carrying out a statistic calculation, a fee calculation, a data backup and a data deletion and the function indicative of a combination thereof, as subclasses 71 through 75.

The system management class 44 is a class for controlling a group of system management functions, and has the function of carrying out a master management and an operation management and the function indicative of a combination thereof, as subclasses 81 through 83.

The utility class 45 is a class for controlling a group of utility functions, and has the function of carrying out printing, mail transmission, data generation, data WWW disclosure, certification, mail notification, data acquisition and data presentation and the function indicative of a combination thereof, as subclasses 91 through 99.

Furthermore, the service function group combination class 46 is a class for controlling a combination of functions of a business application system to be designed.

When the functional configuration of the business application system to be designed is generated, a desired function element is selected from a group of functions included in the class library shown in FIG. 14, to derive a subclass from a class corresponding to the selected function element to directly generate the functional configuration of the application system to be designed, as a group of classes.

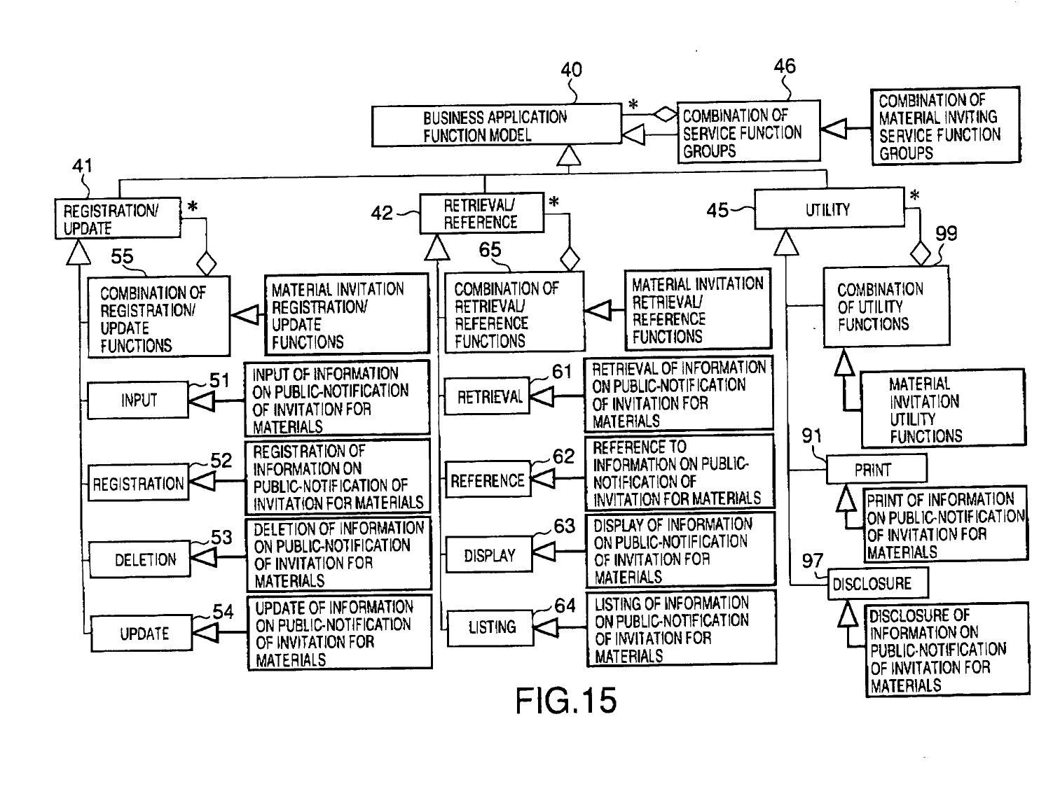

FIG. 15 is a diagram showing a result of selection and derivation of a class corresponding to a function element from the class library shown in FIG. 14, with respect to the information on public-notification of invitation for materials, which is prepared in the material inviting service of the article procuring service shown in FIGS. 9(a) and 9(b).

As shown in FIG. 15, in this case, a subclass corresponding to the function of the material inviting service (a class for inputting information on public-notification of invitation for materials, a class for registering information on public-notification of invitation for materials, a class for deleting information on public-notification of invitation for materials, and a class for updating information on public-notification of invitation for materials) is derived from the classes 51 through 54 corresponding to the function of inputting, registering, deleting and updating information, of the group of registration/update functions. In addition, a subclass (a function class for registering/updating the invitation for materials) is derived from the registration/update function combination class 55.

A subclass corresponding to the function of the material inviting service (a class for retrieving information of public-notification of invitation for materials, a class for referring to information of public-notification of invitation for materials, a class for indicating information of public-notification of invitation for materials, and a class for listing information of public-notification of invitation for materials) is derived from the classes 61 through 64 corresponding to the function of retrieving, referring to, displaying and listing information, of the group of retrieval/reference functions. A subclass corresponding to the function of the material inviting service (a function class for retrieving/referring to invitation for materials) is derived from the retrieval/reference function combination class 65.

Moreover, a subclass corresponding to the function of the material inviting service (a class for printing information on public-notification of invitation for materials, and a class for disclosing information on public-notification of invitation for materials) is derived from the classes 91 and 97 corresponding to the function of carrying out printing and data WWW disclosure, of the group of utility functions. A subclass corresponding to the function of the material inviting service (a material invitation utility function class) is derived from the utility function conbination class 99.

In addition, a subclass corresponding to the function of the material inviting service (a combination class of function groups of the material inviting service) is derived from the service function group combination class 46.

Furthermore, any functions are not selected from the batch processing function group and the system management function group.

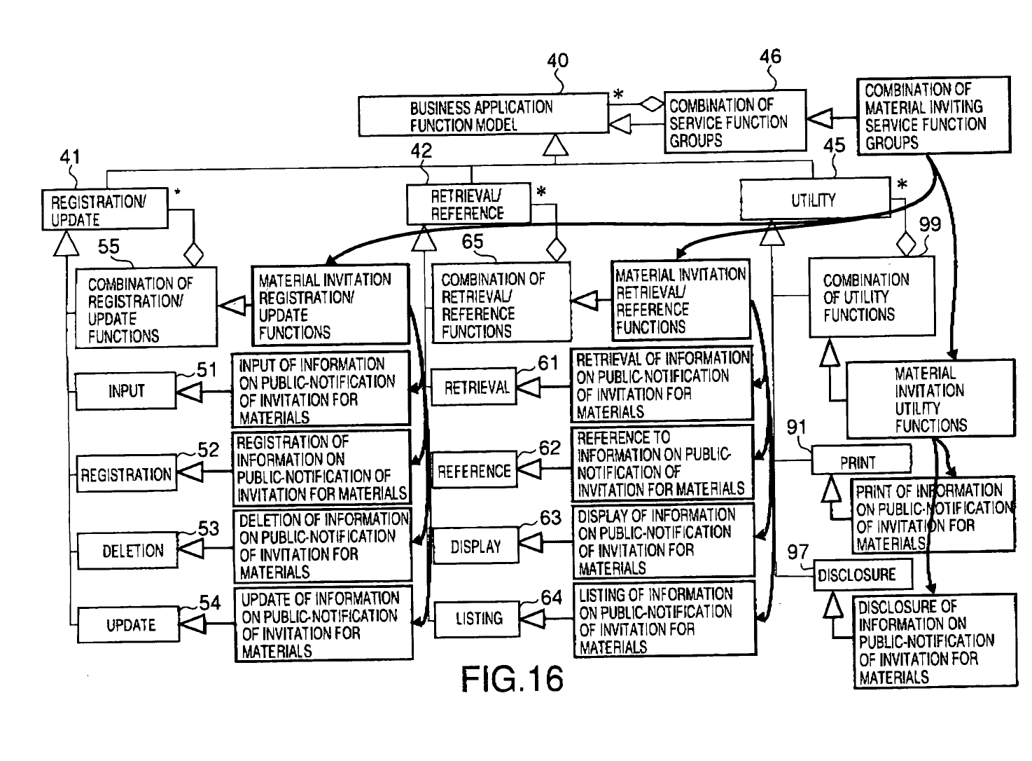

The combination of the subclasses derived as shown in FIG. 15, and the relationship between controls are assigned after all of the subclasses are derived. FIG. 16 is a diagram showing the results of assignment.

As shown in FIG. 16, the combination class of function groups of the material inviting service controls three classes (a function class for registration/update of invitation for materials, a function class for retrieval/reference of invitation for materials, and a function class for utility of invitation for materials), and assigns that the material inviting service comprises function groups for registration/update, retrieval/reference and utility.

The function class for registration/update of invitation for materials controls four classes (a class for inputting information on public-notification of invitation for materials, a class for registering information on public-notification of invitation for materials, a class for deleting information on public-notification of invitation for materials, and a class for updating information on public-notification of invitation for materials), and assigns that the processing for registering and updating information on invitation for materials comprises four functions.

Moreover, the function class for retrieval/reference of invitation for materials controls four classes (a class for retrieving information on public-notification of invitation for materials, a class for referring to information on public-notification of invitation for materials, a class for indicating information on public-notification of invitation for materials, and a class for listing information on public-notification of invitation for materials), and assigns that the processing for retrieving and referring to information on invitation for materials comprises four functions.

In addition, the function class for utility of invitation for materials controls two classes (a class for printing information on public-notification of invitation for materials, and a class for disclosing information on public-notification of invitation for materials), and assigns that other processes with respect to information on invitation for materials comprise two functions.

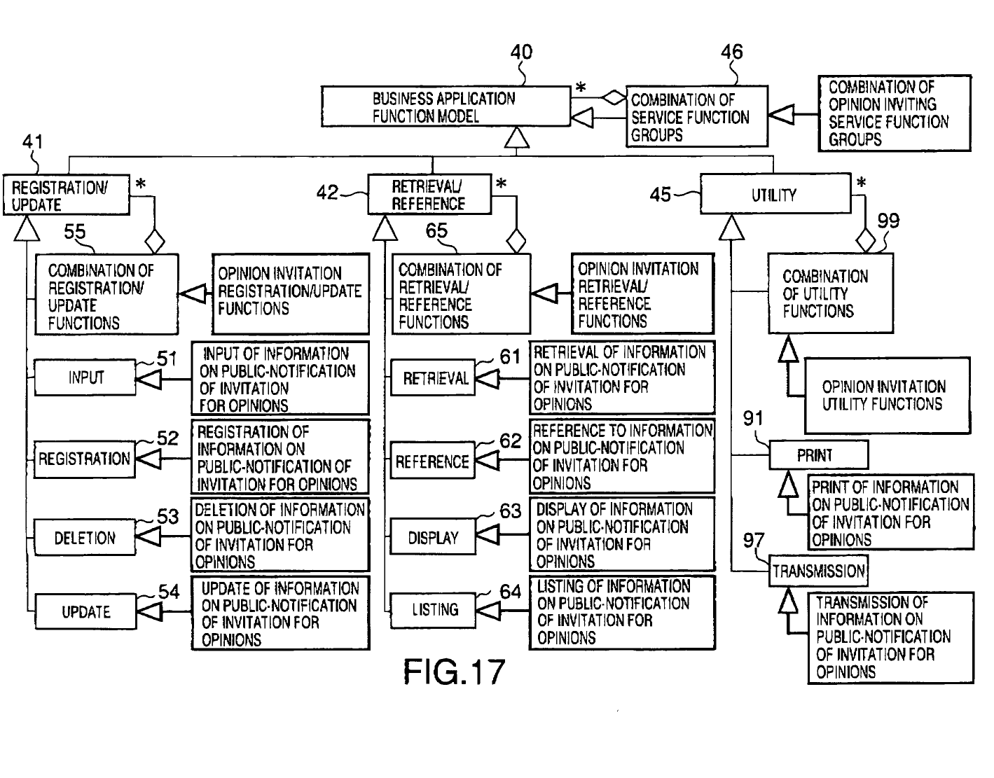

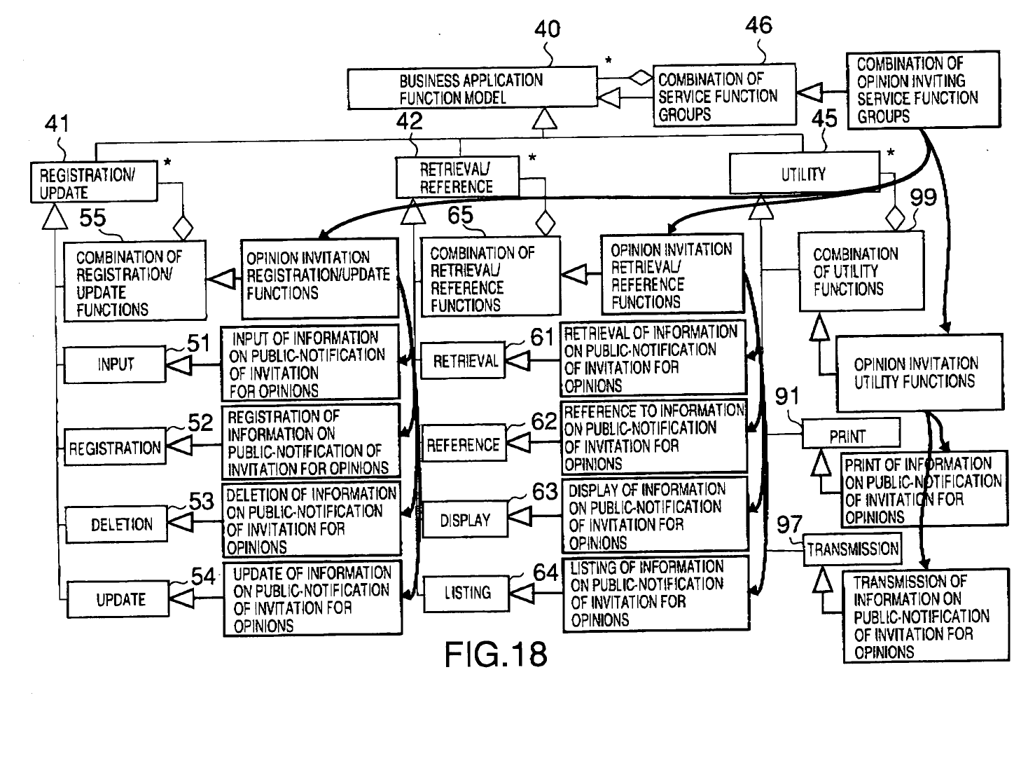

FIGS. 17 and 18 are diagrams showing the results of definition of the functional configuration with respect to the information on public-notification of invitation for opinions, which is prepared in the opinion inviting service of the article procuring service, similar to the process for generating the functional configuration with respect to the material inviting service as shown in FIGS. 15 and 16. Furthermore, the difference from the above described opinion inviting service is that the function of “disclosure” of information on public-notification of invitation for opinion is removed from and the function of “transmission” of information on public-notification of invitation for opinion is added to the function of utility. Other points are the same as the above described material inviting service.

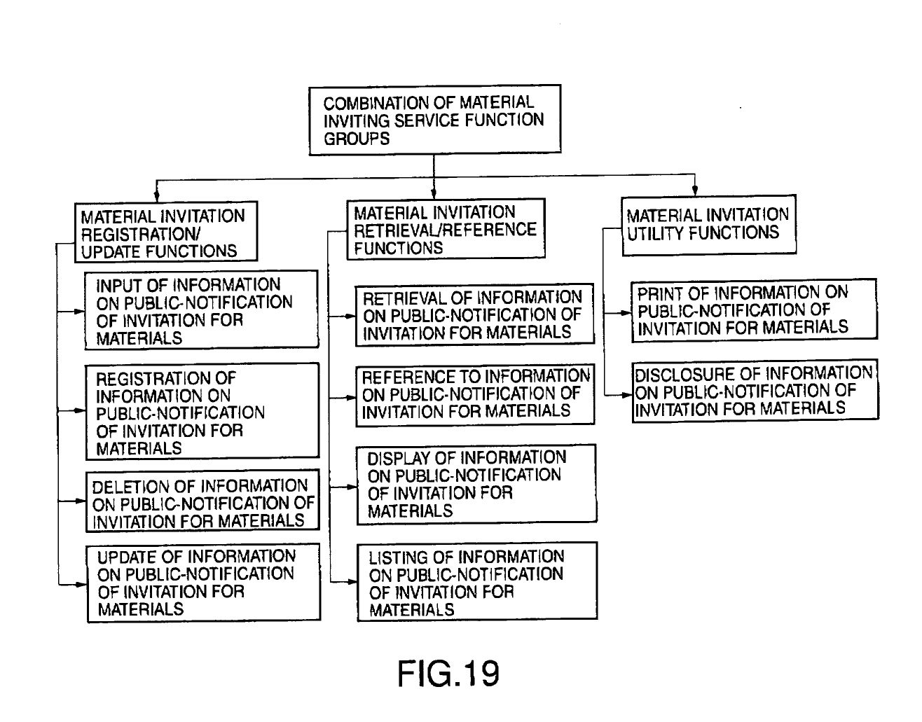

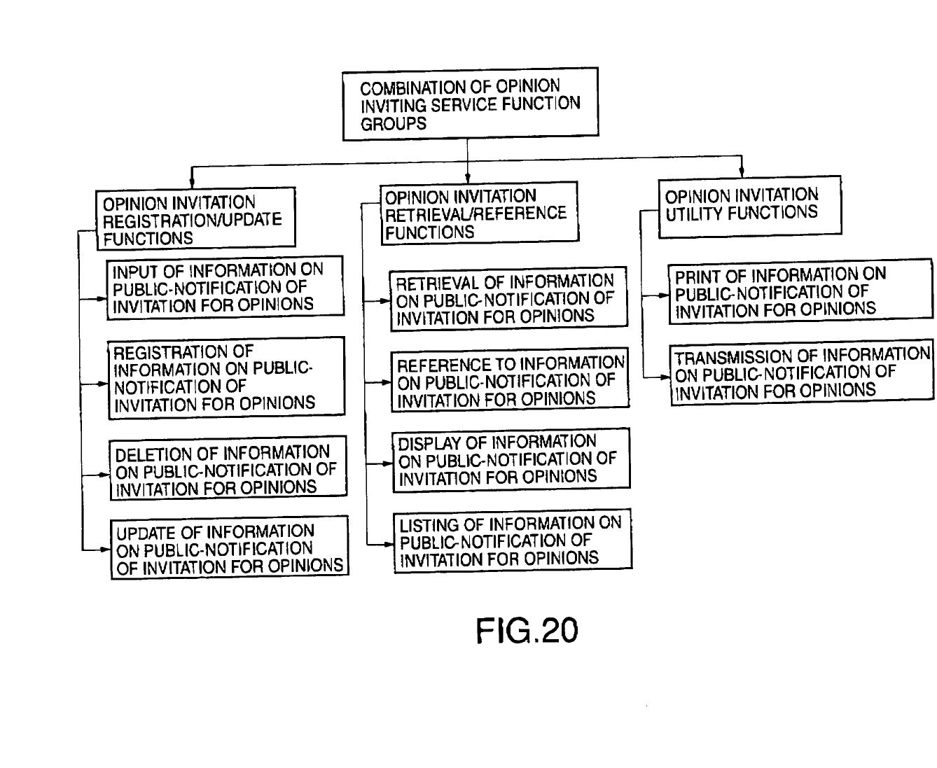

Furthermore, the functional configurations thus defined with respect to the material inviting service and the opinion inviting service are presented to the user in the form shown in FIGS. 19 and 20, via the output control part 12 of the functional configuration definition support system 10.

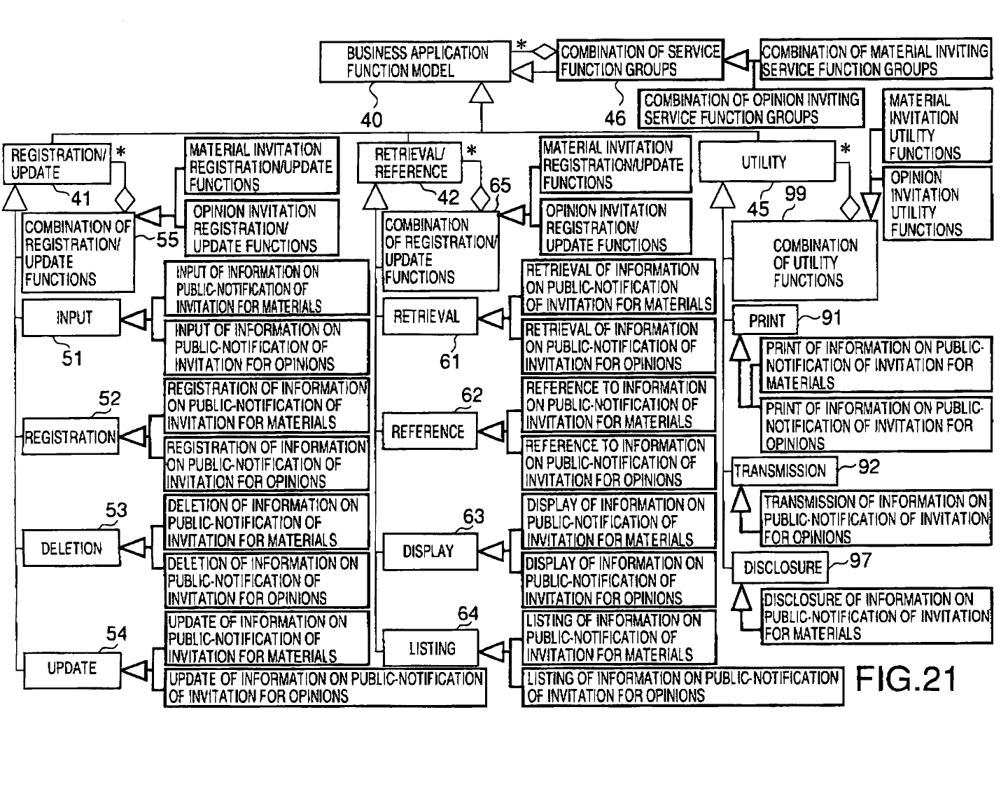

The results of selection and derivation of a class corresponding to a desired function element from the class library shown in FIG. 14, with respect to the material inviting service and the opinion inviting service are integrated and stored in the functional configuration generation result database 15 of the functional configuration definition support system 10 in the form shown in FIG. 21.

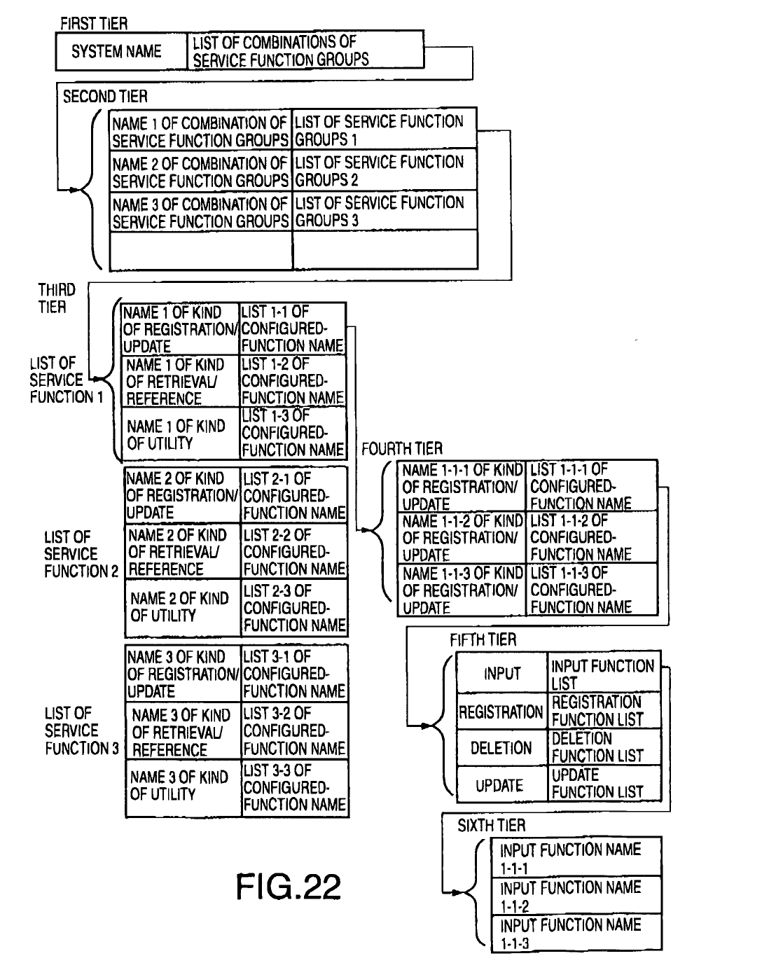

Furthermore, the result of generation of functional configuration can be stored in the functional configuration generation result database 15 in the data format shown in FIG. 22 (a nest type list structure).

As shown in FIG. 22, in this data format, one list is prepared every business application system to be designed, and this list comprises a “system name” and a “service function group combination list” (first tier). The “service function group combination list” comprises a list of combinations of function groups for services with respect to services in the respective stages (second tier). Subsequently, a nest type list structure having six hierarchies is formed as shown in FIG. 22.

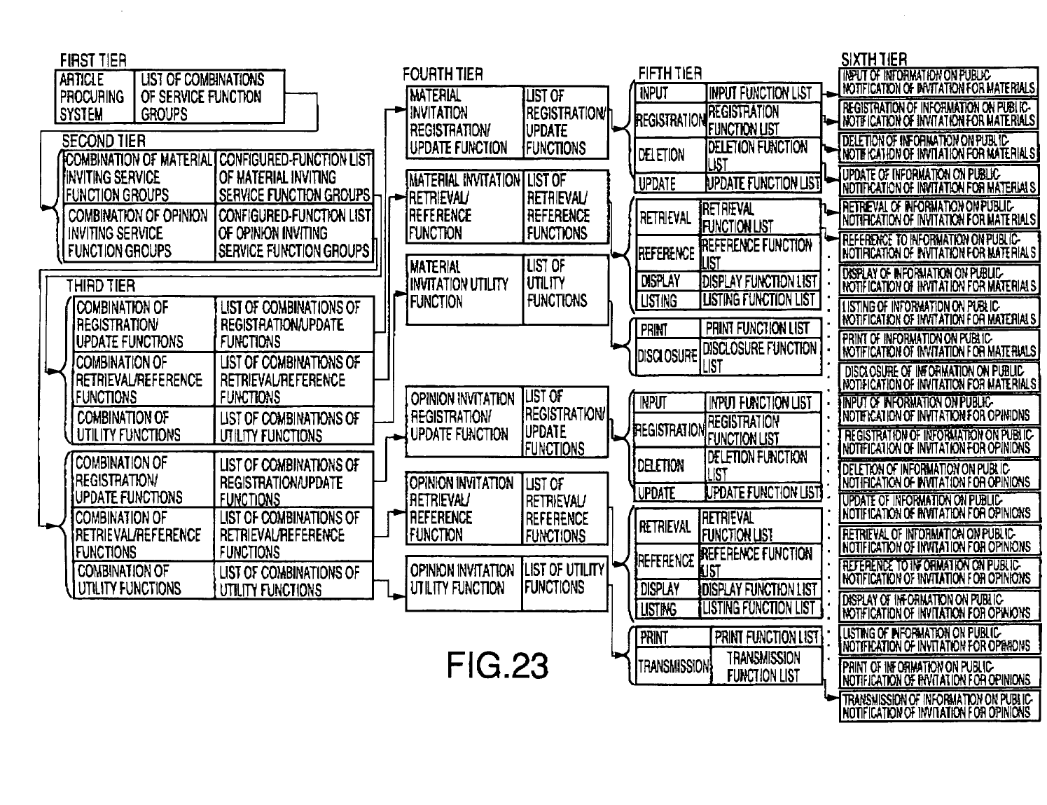

FIG. 23 is a diagram showing an example of a result of generation of functional configuration with respect to the material inviting service and the opinion inviting service, which is expressed in accordance with the form shown in FIG. 22. In order to simplify the figure, the results of generation of functional configuration with respect to the bid public-notifying service, bid accepting service, bid opening service and successful bid public-notifying service are omitted from the figure.

In FIG. 23, elements located on the left side of the second tier correspond to classes derived from the service function combination class. In addition, an element located on the left side of the fourth tier corresponds to a class derived from the registration/update function combination class, the retrieval/reference function combination class, the batch processing function combination class, the system management function combination class, and the utility function combination class. Moreover, an element located on the left side of the sixth tier corresponds to a class derived from an input class, a registration class, a delete class, an update class, a retrieval class, a reference class, a display class, a list class, a statistic calculation class, . . . , printing class, certification class, . . . , presentation class.

Furthermore, the result of generation of functional configuration stored in the form shown in FIG. 23 can refer to the functional configuration from various standpoints, by searching data linked to the corresponding data in view of data located in a specific tier. For example, by retrieving data inheriting the “registration/update” of the third tier in FIG. 23, it is possible to extract the registration/update functions of both of the material inviting service and the opinion inviting service. In addition, by noticing the “input” of the fifth tier in FIG. 23, it is possible to extract functions with respect to the input of information on public-notification of invitation for materials and the input of information on public-notification of invitation for opinions, in the registration/update functions. Thus, it is possible to control and refer to the components of the functional configuration separately defined every stage of services, so that it is useful for certifying and reusing the functional configuration.

As described above, according to the present invention, it is possible to reduce the time required to carry out the requirements definition step, and it is possible to define a unified functional configuration, so that it is possible to efficiently share and reuse common components.

While the present invention has been disclosed in terms of the preferred embodiment in order to facilitate better understanding thereof, it should be appreciated that the invention can be embodied in various ways without departing from the principle of the invention. Therefore, the invention should be understood to include all possible embodiments and modification to the shown embodiments which can be embodied without departing from the principle of the invention as set forth in the appended claims.

What is claimed is:

1. A method of defining a functional configuration of a business application system to be designed, said method comprising the steps of:
defining a workflow indicating a flow of services;
extracting, from the defined workflow, information utilized or prepared in each stage of the flow of services; and
generating a functional configuration of the business application system to be designed, by choosing a desired function element with reference to a function model representing a typical functional configuration of a general business application system, for every extracted information, and customizing the chosen function element in accordance with the extracted information.

2. The method according to claim 1, further comprising the step of selecting a desired result of generation of functional configuration from a plurality of results of generation of functional configuration generated in the past, wherein at said step of generating the functional configuration, said desired function element is chosen with reference to the selected result of generation of functional configuration, and said function model.

3. The method according to claim 1, wherein said function model includes: a registration/update function group for inputting, registering, deleting and updating information; a retrieval/reference function group for retrieving, referring to, displaying and listing information; a batch processing function group for carrying out a statistic calculation, a fee calculation, a data backup and a data deletion; a system management function group for carrying out a master management and an operation management; and a utility function group for carrying out printing, mail transmission, data generation, data WWW disclosure, certification, mail notification, data acquisition and data presentation.

4. A system of supporting a def inition of a functional configuration of a business application system to be designed, said system comprising:
a function model database that stores a function model representing a typical functional configuration of a general business application system; and
a functional configuration defining part that generates a functional configuration of the business application system to be designed, on the basis of the function model stored in said function model database, in accordance with input information inputted by a user,
wherein said functional configuration defining part includes: a workflow definition support part that supports a definition of a workflow indicating a flow of services; a utilization/preparation information extraction support part that supports an extraction of information utilized or prepared in each stage of the flow of services, on the basis of the workflow defined by said workflow definition support part; and a functional configuration generating part that generates a functional configuration of the business application system to be designed, by allowing a user to choose a desired function element with reference to the function model stored in said function model database, for every information extracted by said utilization/preparation information extraction support part, and customizing the chosen function element in accordance with the extracted information.

5. The system according to claim 4, further comprising a functional configuration generation result database that stores a plurality of results of generation of functional configuration obtained by said functional configuration defining part, wherein said functional configuration defining part further includes: a functional configuration registering part that registers a functional configuration generated by said functional configuration generating part, in said functional configuration generation result database as a result of generation of functional configuration; and a functional configuration referring part that selects a desired result of generation of functional configuration from a plurality of results of generation of functional configuration registered in said functional configuration generation result database, said functional configuration generating part allowing a user to choose a desired function element with reference to the result of generation of functional configuration selected by said functional configuration referring part, and said function model stored in said function model database.

6. A program product of supporting a definition of a functional configuration of a business application system to be designed, said program causing a computer to execute the procedures of:
supporting a definition of a workflow indicating a flow of services;
supporting an extraction of information utilized or prepared in each stage of the flow of services, on the basis of the defined workflow; and
generating a functional configuration of the business application system to be designed, by allowing a user to choose a desired function element with reference to a function model representing a typical functional configuration of a general business application system, for every extracted information, and customizing the chosen function element in accordance with the extracted information.

7. The program product according to claim 6, further causing the computer to execute the procedure of selecting a desired result of generation of functional configuration from a plurality of results of generation of functional configuration generated in the past, wherein at said procedure of generating the functional configuration, said user is allowed to choose said desired function element with reference to the selected result of generation of functional configuration, and said function model.

8. A function model class library product used for defining a functional configuration of a business application system, said function model class library product comprising:
a function model class for controlling a function group of a business application system;
a service function group combination class inherited from said function model class and controlling a combination of function groups of the business application system to be designed;
a registration/update class inherited from said function model class and controlling a registration/update function group;
a retrieval/reference class inherited from said function model class and controlling a retrieval/reference function group;
a batch processing class inherited from said function model class and controlling a batch processing function group;
a system management class inherited from said function model class and controlling a system management function group; and
a utility class inherited from said function model class and controlling a utility function group.

9. The function model class library product according to claim 8, wherein said registration/update class has a function of inputting, registering, deleting and updating information and a function indicative of a combination thereof, as subclasses; said retrieval/reference class has a function of retrieving, referring to, displaying and listing information and a function indicative of a combination thereof, as subclasses; said batch processing class has a function of carrying out a statistic calculation, a fee calculation, a data backup and a data deletion and a function indicative of a combination thereof, as subclasses; said system management class has a function of carrying out a master management and an operation management and a function indicative of a combination thereof, as subclasses; said utility class has a function of carrying out printing, mail transmission, data generation, data WWW disclosure, certification, mail notification, data acquisition and data presentation and a function indicative of a combination thereof, as subclasses.
